(19) United States
(12) Patent Application Publication
(10) Pub. No.: US 2006/0053087 A1
(43) Pub. Date: Mar. 9, 2006

(54) System and method for deploying enterprise components using deployment descriptors

(76) Inventor: Vladimir K. Pavlov, Sofia (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/864,227

(22) Filed: Jun. 8, 2004

(51) Int. Cl. G06F 17/30

(52) U.S. Cl. 707/1

(57) ABSTRACT

System and method for deploying enterprise components using a deployment descriptor are described herein. In one embodiment, a deployment module of an enterprise container parses a deployment descriptor (DD) for deploying one or more enterprise components. For each of the enterprise components being deployed, the deployment module retrieves from the DD mapping information for mapping one or more persistent fields to one or more columns of a database table, where for each persistent field, the mapping information includes names of the persistent field and the columns of the database table where the persistent field being mapped to. Thereafter, the deployment module populates each of the persistent fields of each enterprise component in the database table based on the mapping information during a deployment of the enterprise component. Other methods and apparatuses are also described.

### FIELD OF THE INVENTION

The present invention relates generally to enterprise applications. More particularly, this invention relates to deploying enterprise components using deployment descriptors.

### BACKGROUND OF THE INVENTION

Java 2 Enterprise Edition (“J2EE”) is a specification for building and deploying distributed enterprise applications. Unlike traditional client-server systems, J2EE is based on a multi-tiered architecture in which server side program code is divided into several layers including a “presentation” layer and a “business logic” layer.

FIG. 1 illustrates an exemplary J2EE application server 100 in which the presentation layer is implemented as a Web container 111 and the business layer is implemented as an Enterprise Java Bean (“EJB”) container 101. Containers are runtime environments which provide standard common services 119, 109 to runtime components. For example, the Java Naming and Directory Interface (“JNDI”) is a service that provides application components with methods for performing standard naming and directory services. Containers also provide unified access to enterprise information systems 117 such as relational databases through the Java Database Connectivity (“JDBC”) service, and legacy computer systems through the J2EE Connector Architecture (“JCA”) service. In addition, containers provide a declarative mechanism for configuring application components at deployment time through the use of deployment descriptors (described in greater detail below).

As illustrated in FIG. 1, each layer of the J2EE architecture includes multiple containers. The Web container 111, for example, is itself comprised of a servlet container 115 for processing servlets and a Java Server Pages (“JSP”) container 116 for processing Java server pages. The EJB container 101 includes three different containers for supporting three different types of enterprise Java beans: a session bean container 105 for session beans, an entity bean container 106 for entity beans, and a message-driven bean container 107 for message-driven beans. A more detailed description of J2EE containers and J2EE services can be found in RAGAE GHALY AND KRISHNA KOTHAPALLI, SAMS TEACH YOURSELF EJB IN 21 DAYS (2003) (see, e.g., pages 353-376).

The information systems of a modern day enterprise (such as a corporation or government institution) are often responsible for managing and performing automated tasks upon large amounts of data. Persistent data is that data that “exists” for extended periods of time (i.e., it “persists”). Persistent data is typically stored in a database so that it can be accessed as needed over the course of its existence. Here, complex “database software” (e.g., such as DB2, Oracle, and SQL Server) is often used to read the data and perhaps perform various intelligent functions with it. Frequently, persistent data can change over the course of its existence (e.g., by executing a series of reads and writes to the data over the course of its existence). Moreover, multiple items of different persistent data may change as part of a single large scale “distributed transaction.”

FIG. 2 illustrates the manner in which persistent data is managed in current J2EE environments. Session beans 255-257 comprise the high level workflow and business rules implemented by the application server 100. For example, in a customer relationship management (“CRM”) system, session beans define the business operations to be performed on the underlying customer data (e.g., calculate average customer invoice dollars, plot the number of customers over a given timeframe, . . . etc).

Session beans typically execute a single task for a single client during a “session.” Two versions of session beans exist: “stateless” session beans and “stateful” session beans. As its name suggests, a stateless session bean interacts with a client without storing the current state of its interaction with the client. By contrast, a stateful session bean stores its state across multiple client interactions.

Entity beans are persistent objects which represent data (e.g., customers, products, orders, . . . etc) stored within a database 223. Typically, each entity bean 252 is mapped to a table 260 in the relational database and, as indicated in FIG. 2, each “instance” of the entity bean is typically mapped to a row in the table (referred to generally as an “object-relational mapping”). Two different types of persistence may be defined for entity beans: “bean-managed persistence” and “container-managed persistence.” With bean-managed persistence, the entity bean designer must provide the code to access the underlying database (e.g., SQL statements and/or JDBC commands). By contrast, with container-managed persistence, the EJB container 101 manages the underlying calls to the database.

Each EJB consists of “remote home” and/or “local home” interface and “remote component” and/or “local component” interface, and one class, the “bean” class. The home interface lists the methods available for creating, removing and finding EJBs within the EJB container. The home object is the implementation of the home interface and is generated by the EJB container at deploy time. The home object is used by clients to identify particular components and establish a connection to the components' interfaces. The component interfaces provide the underlying business methods offered by the EJB.

A “deployment descriptor” is an XML file (named “ejb-jar.xml”) that describes how enterprise beans are deployed within the J2EE application server 100. For each CMP entity bean, the deployment descriptor defines “persistent fields” which represent and store a single unit of data, and “relationship” fields which represent and store references to other entity beans. Relationship fields are analogous to foreign keys used in relational database tables. Relationships between entity beans may be defined as “one-to-one” where each entity bean is associated with a single instance of another entity bean, “one-to-many” where each entity bean is associated with many instances of another entity bean, or “many-to-many” where entity bean instances may be related to multiple instances of each other.

An exemplary object model of three entity beans is illustrated in FIG. 3 and an exemplary deployment descriptor describing the three entity beans is illustrated in FIGS. 4a-c. The entity beans include a product entity bean 303 representing one or more products, an order entity bean 301 representing a business order and a customer entity bean 302 representing a customer. As indicated in FIG. 3, a many-to-many relationship exists between the product bean 303 and the order bean 301 (i.e., many different product may be used in many different orders). Similarly, a one-to-many relationship exists between the customer bean 302 and the order bean 301 (i.e., an individual customer may make multiple orders).

The container-managed persistence (“CMP”) fields of the product bean 303 include product Name, Product ID, and Price (identifying the name, product identification code and price, respectively, of each product). The CMP fields for the order bean 301 include Order ID, Order Date, Credit Approved (indicating whether the user's credit card company approved the order) and Order Status; and the CMP fields for the customer bean 302 include social security number (SSN), Age, First Name and Last Name of the customer.

The deployment descriptor illustrated in FIGS. 4a-c includes separate sections 401-403 representing and describing the CMP fields for each entity bean 301-303, respectively. For example, section 401 includes four entries 410-413 (identified by the <cmp-field> XML tags) identifying each of the order entity bean's CMP fields (i.e., Order ID, Order Date, Credit Approved, and Order Status). Entity bean sections 402-403 include similar entries for identifying CMP fields. In addition, for each entity bean, one particular CMP field is identified as the primary key field using the <primkey-field> tag 414-416 (e.g., Order ID for the order bean 301).

A <relationships> section 405 of the deployment descriptor (see FIG. 4b) defines the relationships between each of the entity beans 301-303. Each entity bean relationship is defined under a separate <ejb-relation> tag 406, 407. For example, the one-to-many relationship between the order bean 301 and the customer bean 302 is described by setting the <multiplicity> tag 430 associated with the order bean 301 to “many” and setting the <multiplicity> tag 431 associated with the customer bean 302 to “one.” Similar descriptions are provided under <ejb-relation> tag 407 to define the many-to-many relationship between the order bean 301 and the product bean 303.

Thus, the standard deployment descriptor, ejb-jar.xml, defines the various CMP fields for each entity bean and the relationships between entity beans. However, non-standard fields or parameters have not been provided in the standard deployment descriptor.

### SUMMARY OF THE INVENTION

System and method for deploying enterprise components using a deployment descriptor are described herein. In one embodiment, a deployment module of an enterprise container parses a deployment descriptor (DD) for deploying one or more enterprise components. For each of the enterprise components being deployed, the deployment module retrieves from the DD mapping information for mapping one or more persistent fields to one or more columns of a database table, where for each persistent field, the mapping information includes names of the persistent field and the columns of the database table where the persistent field is being mapped to. Thereafter, the deployment module populates each of the persistent fields of each enterprise component in the database table based on the mapping information during a deployment of the enterprise component.

In another embodiment, the deployment module parses a deployment descriptor (DD) for deploying one or more enterprise components. For each of the enterprise components being deployed, deployment module retrieves from the DD an initial cache size specifying a size of a cache memory initially allocated to the enterprise component when the enterprise component is being deployed and allocates a cache memory for the enterprise component having a size according to the initial cache size retrieved from the DD during a deployment of the enterprise component.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 illustrates several layers within a prior art J2EE architecture.

FIG. 2 illustrates a prior art object/relational mapping between an entity bean and a relational database table.

FIG. 3 illustrates an object model of three exemplary entity beans.

FIGS. 4A-4C illustrate an exemplary standard deployment descriptor employed within a J2EE environment.

FIG. 5 is a block diagram illustrating an exemplary enterprise container where one or more enterprise components are deployed according to one embodiment of the invention.

FIG. 6 is a block diagram illustrating an exemplary document type definition (DTD) of an extended deployment descriptor for persistent data according to one embodiment of the invention.

FIGS. 7A-7C are block diagrams illustrating an exemplary persistent deployment descriptor written in an XML format, according to one embodiment of the invention.

FIG. 8 is a flow diagram illustrating an exemplary process for processing deployment descriptors according to one embodiment of the invention.

FIG. 9 is a flow diagram illustrating an exemplary process for processing deployment descriptors according to another embodiment of the invention.

FIG. 10 is a block diagram illustrating an exemplary document type definition (DTD) of an extended deployment descriptor for an enterprise engine according to one embodiment of the invention.

FIGS. 11A-11B are block diagrams illustrating an exemplary enterprise engine deployment descriptor written in an XML format, according to one embodiment of the invention.

FIG. 12 is a flow diagram illustrating an exemplary process for processing deployment descriptors according to one embodiment of the invention.

FIG. 13 is a flow diagram illustrating an exemplary process for processing deployment descriptors according to another embodiment of the invention.

FIG. 14 is a block diagram illustrating an exemplary data processing system which may be used with an embodiment of the invention.

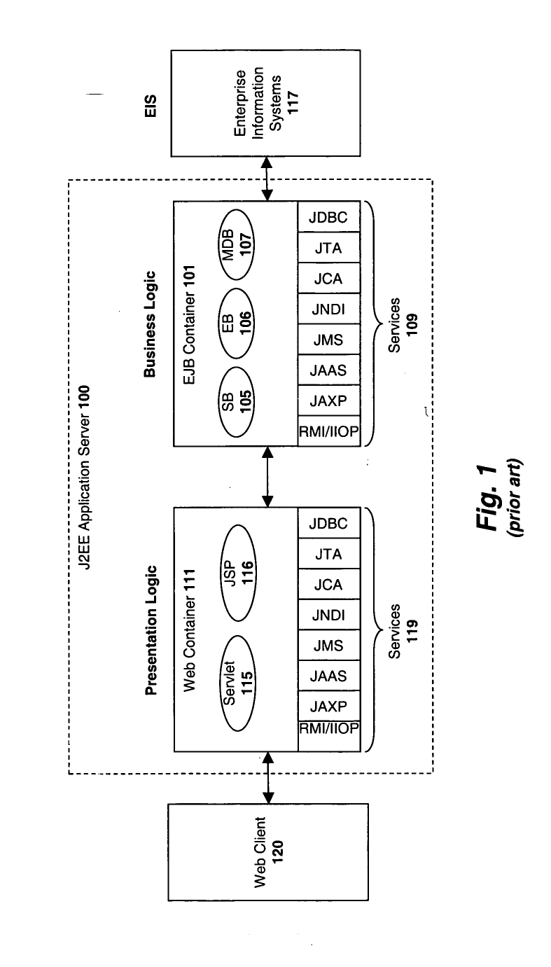

### DETAILED DESCRIPTION

System and method for deploying enterprise components using a deployment descriptor are described herein. In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Exemplary Enterprise Container

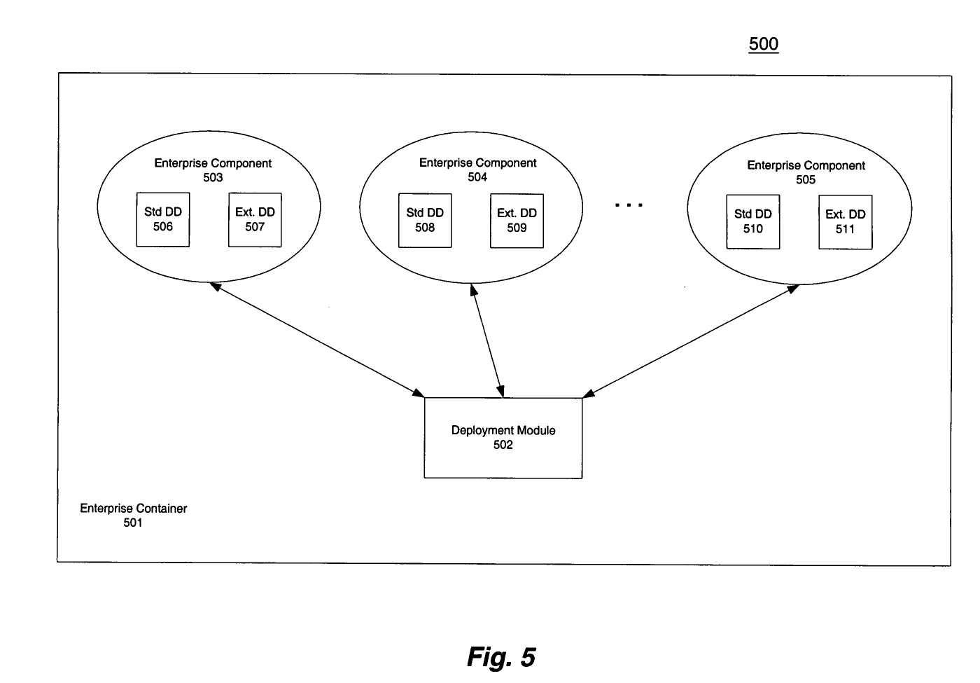

FIG. 5 is a block diagram illustrating an exemplary enterprise container where one or more enterprise components are deployed according to one embodiment of the invention. Note that throughout this application, Java enterprise environments have been used as an example to illustrate embodiments of the invention. It will be appreciated that the embodiments of the inventions are not limited to Java enterprise environments. Other enterprise environments, such as, for example, the NET framework from Microsoft may be applied.

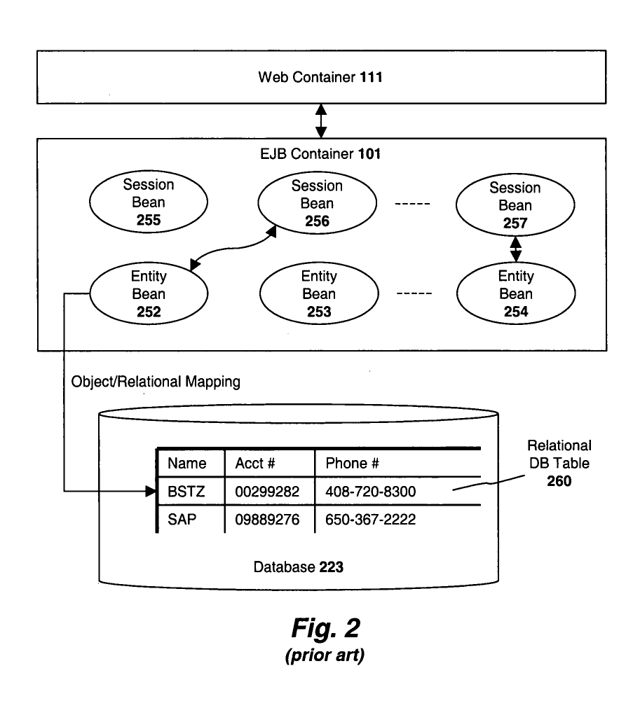

Referring to FIG. 5, for example, exemplary enterprise container 501 is an enterprise Java bean (EJB) container. The exemplary EJB container 501 may be implemented as EJB container 101 of FIG. 2. Within the EJB container 501, one or more enterprise components, such as, EJBs 503-505, may be deployed. EJBs 503-505 may be an entity bean, such as, for example, entity beans 252-254 of FIG. 2. Alternatively, EJBs 503-505 may be a session bean, such as, for example, session beans 255-257. In addition, EJB container 501 includes a deployment module 502 for deploying the EJBs 503-505.

In one embodiment, each of the EJBs 503-505 may include one or more deployment descriptors 506-511 having deployment information for deploying the respective EJB. In one embodiment, each of the EJBs may include a standard deployment descriptor and an extended deployment descriptor. For example, EJB 503 may include a standard deployment descriptor 506 and an extended deployment descriptor 507. In one embodiment, both of the standard and extended deployment descriptors may be implemented as extensible markup language (XML) files.

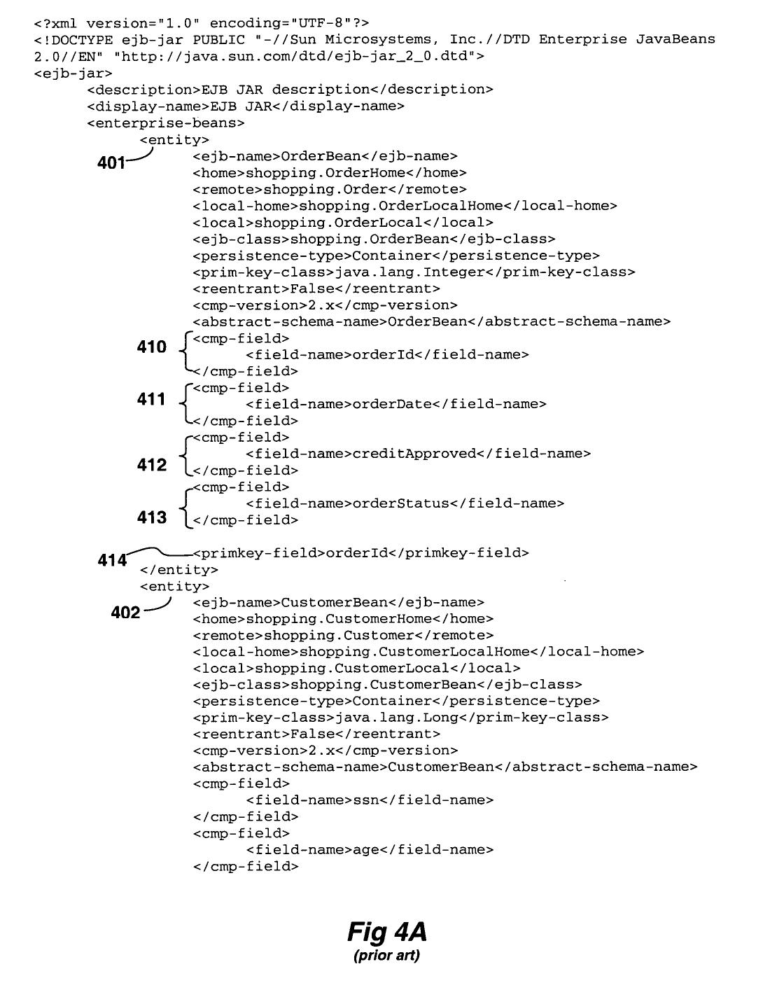

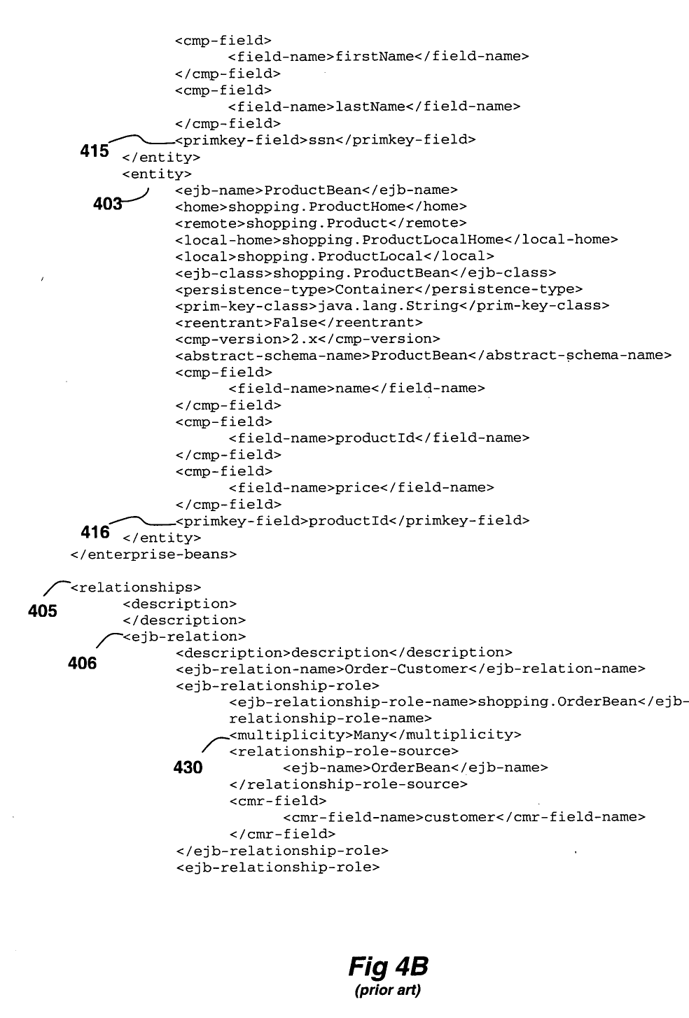

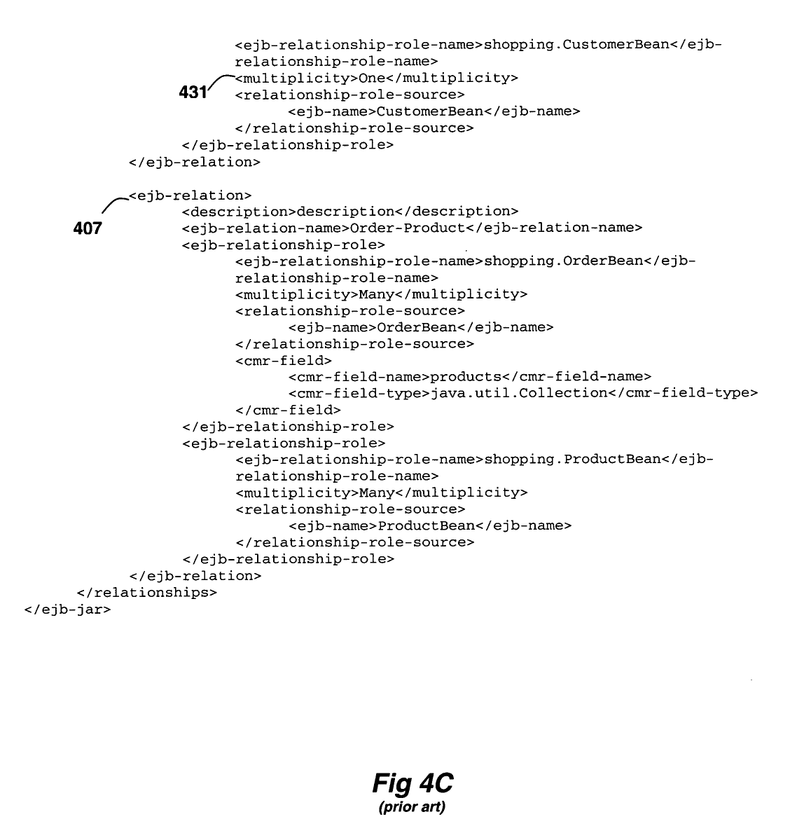

The standard deployment descriptor may be a deployment descriptor in the enterprise computing industry, such as, for example, ejb-jar.xml as shown in FIGS. 4A-4C. The extended deployment descriptor may be a deployment descriptor that is customized to the specific EJB being deployed. In one embodiment, the extended deployment descriptor includes deployment information that is not found or recognized by the standard deployment descriptor. The extended deployment descriptor may have different name than the standard deployment descriptor and may be packaged within the same directory of the standard deployment descriptor. In one embodiment, multiple extended deployment descriptors may be implemented. In a particular embodiment, a first extended deployment descriptor may be designed for providing deployment information for J2EE engine in general (e.g., ejb-j2ee-engine.xml) and a second extended deployment descriptor may be designed for providing deployment information for persistent data of the EJB (e.g., persistent.xml). Other configurations may exist.

When an EJB is deployed, the deployment module 502 may parse the deployment descriptors associated with the respective EJB, including the standard and extended deployment descriptors. The deployment module 502 retrieves the necessary deployment information from the deployment descriptors and uses the retrieved information to configure the respective EJB during the deployment of the EJB. As a result, an application developer can specify detailed configuration information for an enterprise component (e.g., EJB) via one or more deployment descriptors without having to change (e.g., recompiling) the source code, which provides great flexibilities.

Exemplary Persistent Deployment Descriptors

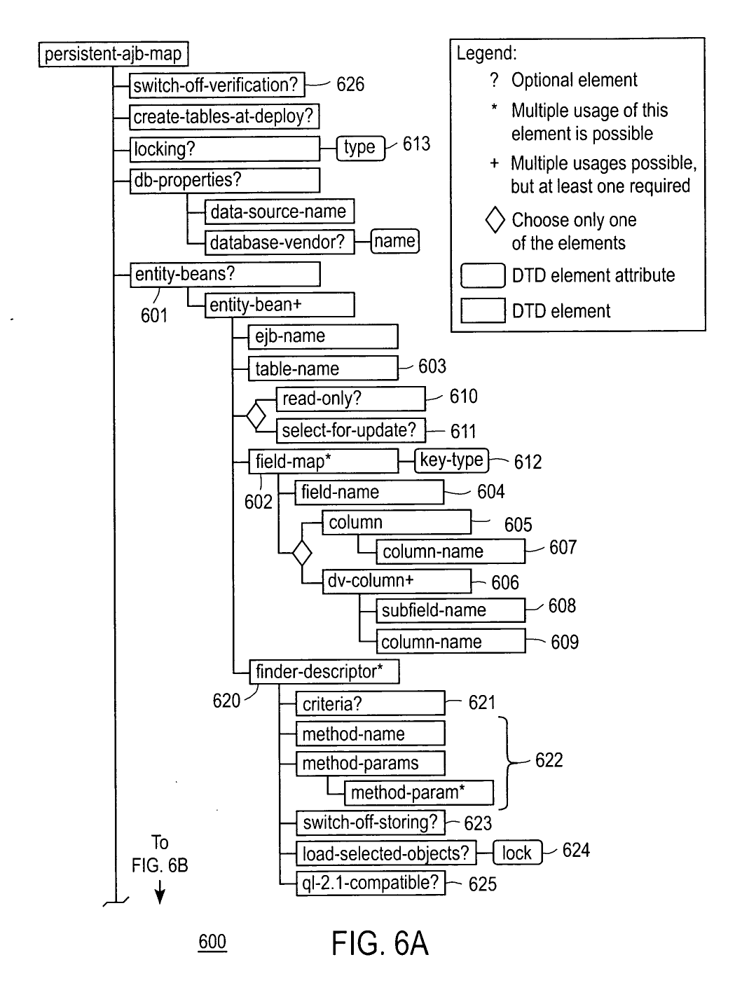

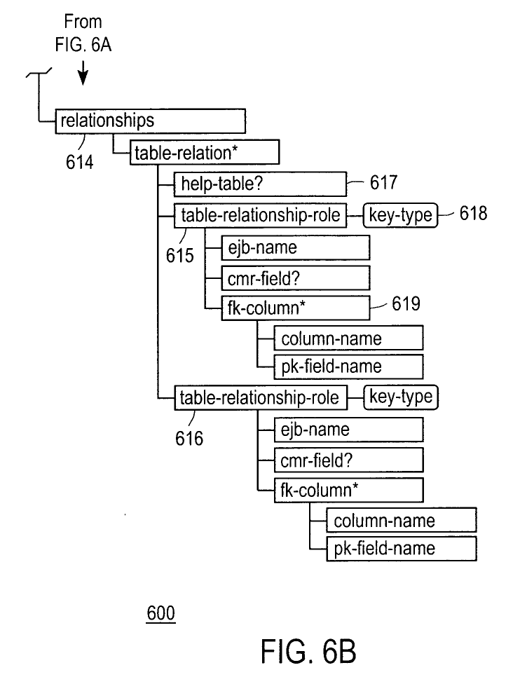

FIG. 6 is a block diagram illustrating an exemplary document type definition (DTD) of an extended deployment descriptor for persistent data according to one embodiment of the invention. Note that exemplary DTD 600 is described for illustration purposes only. It will be appreciated that exemplary DTD 600 is not limited to those elements shown in FIG. 6. Other elements may also be implemented.

Referring to FIG. 6, in one embodiment, exemplary DTD 600 includes an entity-bean section 601 for defining deployment parameters in addition to those defined in a standard deployment descriptor. Each entity-bean section may include one or more field-map sections 602 to map a persistent data field (e.g., a CMP field) to a column (identified by column tag 605 as a single column) of a database table that is identified by a table-name tag 603.

In one embodiment of the invention, each persistent field of each persistent data object is mapped to a single column or a set of columns. Prior to mapping, each persistent field (also referred to as a “cmp-field”) is classified as Type1, Type 2 or Type 3. Type 1 is a “settable” cmp-field (i.e., a cmp-field mapped to one column as described below); Type2 is a “non settable” cmp-field stored in one column (also mapped to one column); and Type3 is a “non settable” cmp-field stored in a set of columns. Type 3 includes type “dependent value class” and the “dependent value class” which should have an empty constructor and public modifier for all its persistent subfields.

A “settable” type is a java type that can be mapped to a proper JDBC type (i.e., proper set/get<Type> methods are provided for it in the JDBC API). A “settable” cmp-field is a field with “settable” type. Each “non settable” cmp-field may be mapped to one column in the database. Its value is serialized/desterilized before/after the database operations described herein. In one embodiment, a “non-settable” cmp-field may be mapped to a set of columns if the following requirements are fulfilled: (1) the cmp-field's class has an empty constructor; and (2) its “persistent subfield” is a field in the dependent value class that intends to be stored in a separate column in the database. The “persistent subfield” should be subset of public fields of the dependent value class and should have “settable” java type. As described below, the names of the “persistent fields” in the persistence descriptor are specified using the tag <dv-column>/<subfield-name>. The term “dependent value persistent field” is equivalent to Type2 (“non settable” cmp-field) or Type3 (“non settable” cmp-field stored in a set of columns).

In one embodiment, if the persistent data field is a dependent-value field and if it contains an empty constructor, the database mapping of its fields that are declared public may be declared in the dv-column tag 606, where the persistent data field may be mapped to multiple columns, which may be identified by subfield-name 608 and column-name 609. However, according to one embodiment, both dependent value and non-dependent value persistent data field mappings may be described in the column tag 605. In this case, the dependent value persistent data field may be serialized and stored in a java.sql.Types.BLOB column.

If a persistent field is a dependent-value persistent field then, in one embodiment of the invention, it is mapped to a single column of type java.sql.Types.BLOB or to a set of columns. As is known in the art, BLOB is a type that stores a “Binary Large Object” as a column value in a row of a database table. By default, drivers implement BLOB using an SQL locator (BLOB), which means that a BLOB object contains a logical pointer to the SQL BLOB data rather than the data itself. Methods provided with the interfaces ResultSet, CallableStatement, and PreparedStatement (e.g., getBlob and setBlob) provide access to SQL BLOB values. The BLOB interface defined in the Java specification provides methods for retrieving the length of an SQL BLOB value, for materializing a BLOB value on a client, and for determining the position of a specific pattern of bytes within a BLOB value. In addition, the BLOB interface includes methods for updating a BLOB value.

If the dependent-value class has an empty constructor and all its fields are public, then the dependent-value persistent field is mapped to a set of columns. These columns are not stored in a separate database table; they are stored in the same database table as the other persistent fields of the bean. If at least one private field exists, or the constructor is not empty, then the dependent value class is mapped to a single column of type java.sql.Types.BLOB. The dependent-value object is serialized and is stored in the database as a byte[ ]. In this case the default mapping may not be permitted to be changed.

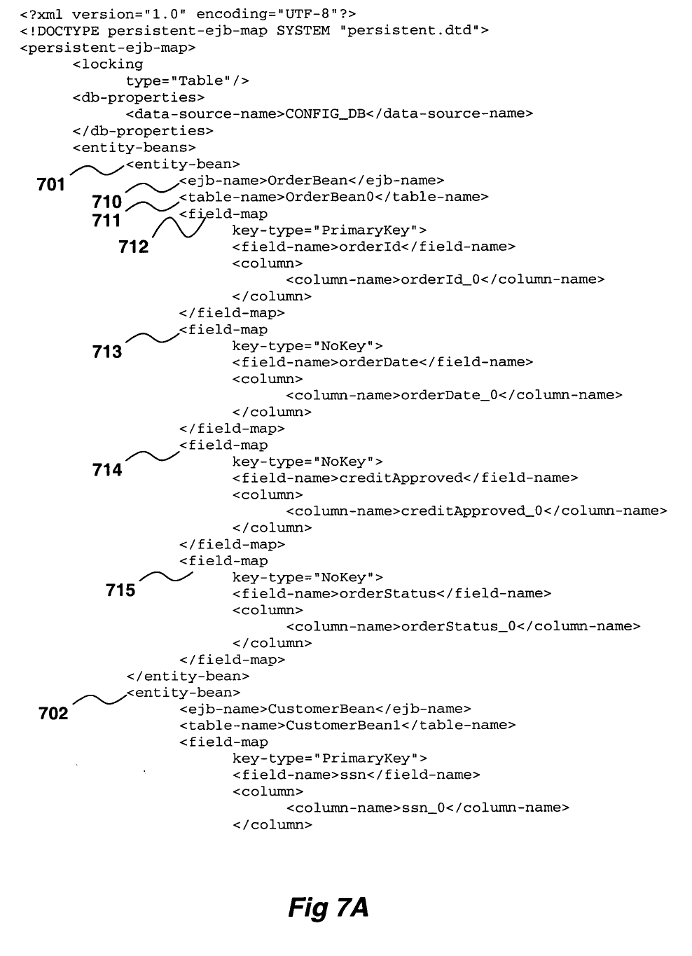

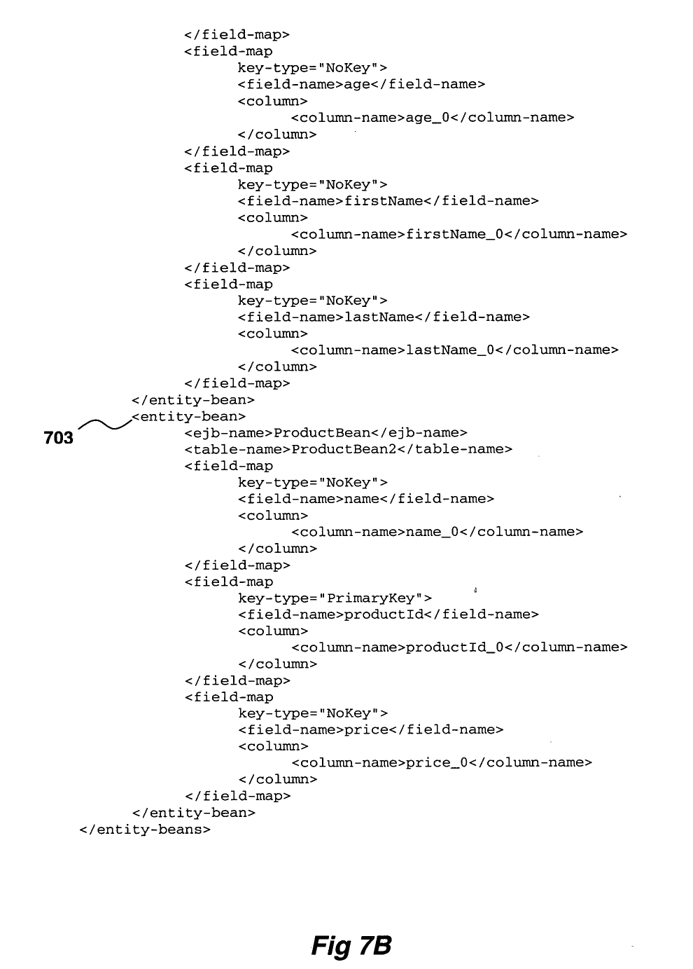

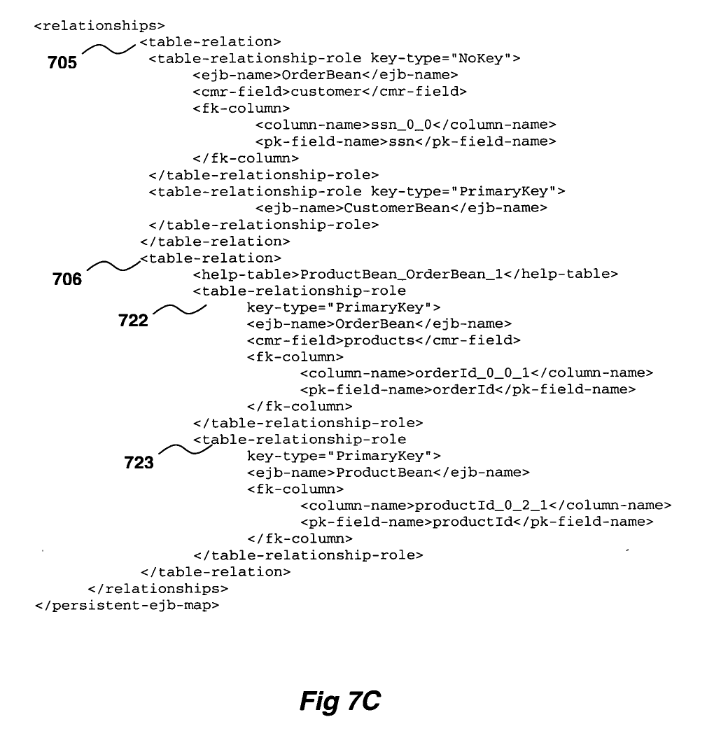

In one embodiment, column names for cmp-fields are selected according to the following rules. For persistent fields of Type1 (“settable” cmp-fields) or Type2 (“non settable” cmp-fields stored in one column), the name of the column is generated concatenating the name of the cmp-field, followed by UNDERSCORE, followed by index 0. For cmp-fields of Type3 (“non settable” cmp-fields stored in a set of columns), the name of the column is generated concatenating the name of the persistent subfield, followed by UNDERSCORE, followed by an index. An example of a descriptor, which is written in XML as an example, according to the DTD shown in FIG. 6 is illustrated in FIGS. 7A-7C.

In one embodiment, key-type tag 612 associated with the field map section 602 may be used to specify the type of the column or the set of columns, in which the values of the persistent data field are stored. The value of the key-type tag 612 may be one of a “NoKey”, a “PrimaryKey”, and a “UniqueKey”, which is used to identify a column of the database table. The default value of the key-type tag 612 may be a “NoKey”.

Optionally, according to one embodiment, when a read-only tag 610 exists, the respective entity bean is not allowed to update the data in the database table. In this situation, the respective entity bean can only be allowed to read data from the database table. Alternatively, according to an alternative embodiment, when a select-for-update tag 611 exists, the respective entity bean identified by the entity-bean section 601 will use the database locking mechanism. The read-only tag 610 and the select-for-update tag 611 may mutually exclusively exist.

In one embodiment, the locking mechanism of the database table may be further controlled by a locking tag 613. The locking tag 613 may be used to control concurrent access from different transactions to the entity beans. According to one embodiment, there may be a variety of different types of locking. For example, the locking may be a table locking that automatically locks the entity beans in the Enqueue server, such that it ensures all applications that run in the cluster and use common data have the common locks. A local locking may be used when there is only one server running, because it does not synchronize the locks on multiple servers that work in a cluster. That is, the local locking synchronizes the concurrent access on one server only, and it does not use the Enqueue server to keep the locks. In this situation, an application may use a function call, such as, an EJBLocking API to make an explicit locking in the Enqueue server. Other locking types, such as, for example, an administrative locking, may also exist.

According to one embodiment, the DTD 600 further includes one or more relationship tags 614 that may be used as relation descriptors. In one embodiment, relations are realized using references between primary key column(s) and foreign key column(s), or “logical foreign key” column(s), which may be identified via a key-type tag 618. A key-type specified in key-type tag 618 may be one of a “NoKey”, a “PrimaryKey”, and a “ForeignKey”. This tag is used to describe a foreign (logical) key column and its reference to the corresponding primary key cmp-field. In such cases, the <fk-column> elements may be mandatory. If the key-type is PrimaryKey, the <fk-column> element should exist only if the relationship has multiplicity many-to-many. The <fk-column> element describes the referenced columns in the help table.

A column is called “a logical foreign key” if it is a column that contains the values of the referenced table's primary key column, but is not declared as a foreign key. As used herein, a “foreign key” column 619 may refer to both standard foreign keys and logical foreign keys. In one embodiment, one or more different foreign key columns are defined for each relationship. For example, if there are N relationships between two entity beans, then there are N mappings between primary keys and foreign key columns.

Relations may be one-to-one, one-to-many, or many-to-many (defining the “cardinality” of the relation). In addition, relations may be unidirectional or bidirectional. A unidirectional relationship can be navigated in only one direction. For example, a “contact” entity bean (representing a contact within an address book) may include a relationship field that refers to an address bean but the address bean may not require a relationship field that refers to the contact bean. By contrast, a bidirectional relationship may be navigated in both directions. For example, an order bean may refer to a series of line items and each of the series of line items may refer back to the order (i.e., so that the order may be identified given a particular line item of that order).

For one-to-one relationships, foreign key columns are provided in at least one of the two tables that participate in the relationship. For unidirectional one-to-one relations, a foreign key column is created in the table mapped to the entity bean which contains relationship field. For bidirectional one-to-one relations, foreign key columns are created in the tables mapped to each entity bean containing the relationship fields (e.g., identified in the first element of the <table-relatidnship-role>/<table-relationship-role> pair 615 and 616 identified under the <relationships> tag 614 in the deployment descriptor).

In one embodiment of the invention, for one-to-many relations, foreign key columns are generated in the table of the bean whose multiplicity in this relationship is “many.” In addition, in one embodiment, for many-to-many relationships, a mapping is provided which contains columns that are foreign key columns referencing the primary key columns of the two tables to which the beans participating in this relationship are mapped. The columns should have the same JDBC type as the primary key columns of the referenced tables. In one embodiment, this mapping is accomplished via a helper table 617.

In one embodiment, the following naming conventions are employed. The name of the foreign key columns is the name of the referenced primary key column, followed by UNDERSCORE, followed by a unique identifier of the relationship that is mapped with this foreign key column. For example, if a relationship with multiplicity 1:M exists between CustomerBean and OrderBean, the primary key column of the CustomerBean is “ssn_{—}0” and the unique relationship ID is 0, as shown in FIGS. 7A-7C as an example. Thus, the unique relationship ID is used to generate different names of foreign key columns in situations when there is more then one relationship between two beans.

In one embodiment, many-to-many relationships between entity beans are represented within the persistence description using a “help table” 617 in which the primary keys of one enterprise bean are associated with the primary keys of a second bean. In one embodiment, the help-table name is selected to be the ejb-name of the CMP bean in the relationship, followed by UNDERSCORE, followed by the ejb-name of the other CMP bean in the relationship, followed by UNDERSCORE, followed by relationship ID. In addition, the name of the foreign key columns in the help-table are the name of the referenced primary key column, followed by UNDERSCORE, followed by the bean ID, followed by UNDERSCORE, followed by a unique identifier of the relationship.

The following is an example of an “ProductBean_OrderBean_{—}1” helper table for two beans, “ProductBean” and “OrderBean”, that have related primary keys (i.e., Product with productId=1 is related to Order with orderId=2; Product with productId=4 is related to Order with orderId=8; Product with productId=1 is related to Order with orderId=1; Product with productId=11 is related to Order with orderId=10):

| productId_0_2_1 | orderId_0_0_1 |
|---|---|
| (Refer to Primary Key Column | (Refer to Primary Key Column |
| productId_0 of table ProdubtBean2) | orderId_0 of table OrderBean0) |
| 1 | 2 |
| 4 | 8 |
| 1 | 1 |
| 11 | 10 |

The foreign key column in the help-table that refers the OrderBean is “orderId_{—}0_{—}0_{—}1” because the name of the primary key column of OrderBean is “orderId_{—}0”, the OrderBean ID is 0, and the relationship ID is 1. The foreign key column in the help-table that refers the ProductBean is “productId_{—}0_{—}2_{—}1” because the name of the primary key column of ProductBean is “productId_{—}0”, the ProductBean ID is 2, and the relationship ID is 1. An example of the help table is shown in FIGS. 7A-7C. In case of M:M relationship the index of the referenced bean is added because if the two beans has the same primary key column name then the referenced foreign key columns will not differ. Note that the above naming conventions are described for illustration purposes only. It will be appreciated that other naming conventions may be implemented.

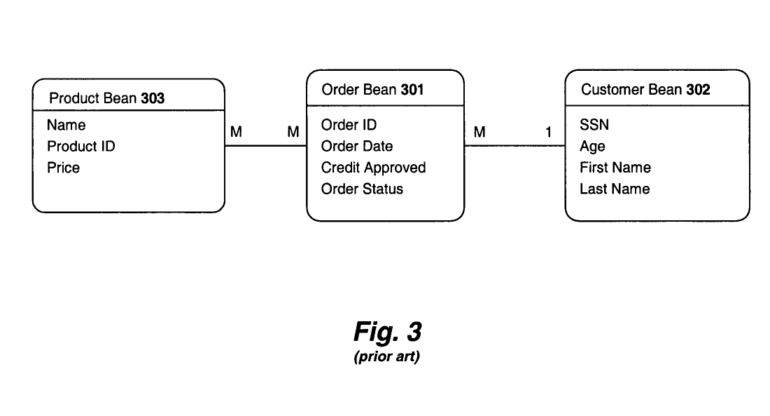

FIGS. 7A-7C are examples of persistent deployment descriptor written in an XML format according to one embodiment of the invention. In this example, entity bean sections 701, 702 and 703 correspond to the order bean 301, customer bean 302 and product bean 303 illustrated in FIG. 3.

Each entity bean section 701, 702, 703 includes a mapping of the entity bean it represents to a database table, and a mapping of the persistent fields of the entity bean to the columns of the database table. For example, entity bean section 701 includes an association between the entity bean name (“OrderBean”) 710 and a table name (“OrderBean0”) 711. In one embodiment, the name of the database table is automatically generated based on the name of the entity bean which represents it (e.g., using the same name or a derivation of the entity bean name). It should be noted, however, that automatic generation of table names is not required for complying with the underlying principles of the invention. For example, an O/R mapping generation logic may map existing database tables to entity beans, rather than generating a new name for each table.

In addition, in one embodiment, the O/R persistence description includes a plurality of field mapping sections 712-715 that map each persistent field of the entity bean to a column in the associated database table. For example, in FIG. 7A, field mapping section 712 maps the “orderID” field to an “orderId_{—}0” column within the “OrderBean0” table. Similarly, field mapping section 713 maps the “orderDate” field to an “orderDate_{—}0” column; field mapping section 714 maps the “creditApproved” field to a “creditApproved_{—}0” column; and field mapping section 715 maps the “orderStatus” field to an “orderStatus_{—}0” column. Similar mapping entries are illustrated in FIGS. 7A-7B for the product bean and customer bean.

FIG. 7C illustrates a portion of the O/R persistence description that maps the relationships between entity beans to database tables. For example, to describe the one-to-many relationship between the customer bean 302 and the order bean 301, table-relation section 705 maps the “customers” relationship descriptor of the order bean to a foreign key column orderId_{—}0_{—}0 of the CustomerBean table mapped to the primary key column orderId of the OrderBean table.

Table-relation section 706 provides the relationship mapping between the order bean 301 and the product bean 303. For example, “table-relationship-role” section 722 maps a foreign key column orderId_{—}0_{—}0_{—}1 in the help-table ProductBean_OrderBean_{—}1 table to the primary key column of the OrderBean0 table; and “table-relationship-role” section 723 maps a foreign key column productId_{—}0_{—}2_{—}1 in the help-table ProductBean_OrderBean_{—}1 to the primary key column of the ProductBean2 table.

Referring back to FIG. 6, according to one embodiment, the exemplary DTD 600 further includes a finder descriptor section 620. If the beans are developed according to the enterprise JavaBeans™ v.1.1 specification, this element describes the SQL select statements for the bean's finder methods.

If the beans are developed according to the enterprise JavaBeans™ v.2.0 specification, this element describes the bean's SQL finder methods, which differ from the default finder statements that are generated by the EJB QL parser. This element also specifies whether data storing for the finder and select methods is switched on or off, which of the bean's fields will be retrieved from the database, and whether the EJB QL is 2.1 compatible.

In one embodiment, a criteria tag 621 may be used to define the select statement that is going to be executed in the finder method. Use format “?I” to specify the number of the parameter, which should be used instead of the statement. Parameters are numbered from 1 to N. An example of such usage is shown as follows:
<criteria>select name_{—}0,order_{—}0 from myTable where order_{—}0=?1 AND order_{—}0=?2</criteria>

The system will not detect whether the criteria is not correct, or whether it returns the wrong result type during the application's deployment. However, the system will throw an exception at runtime when you try to execute the incorrect criteria.

In addition, one or more parameters of the finder method may be further specified in the tags 622. A switch-off-storing tag 623 may be used to specify whether operations of data storing should be performed prior to the finder method being executed. Further, a load-selected-objects tag 624 may be used to specify whether certain objects should be automatically loaded when the finder method is executed. If this element exists, the bean is locked and when the finder/select method is executed, all fields of the bean are loaded from the database. Otherwise, if the element is omitted, only the primary key fields are retrieved from the database. The locking ensures that, until the end of the transaction, the loaded data will remain consistent with the last state of the data in the database and avoids the reloading of the same data when the transaction uses it later again.

By default, each query is QL 2.0 compatible. If an application developer needs to use new functionality of an updated specification, such as, for example, ORDER BY, aggregate functions, and so on, tag 625 may be used to indicate that the QL is 2.1 compatible. If this element exists, the query is considered QL 2.1 compatible. This element is taken into account only if the specified method is an EJB 2.0 finder or select method.

Furthermore, according to one embodiment, a switch-off-verification tag 626 may be used to indicate whether a verification operation can be disabled during a deployment of an enterprise component. If this tag is specified, the verification of whether the O/R mapping is correct will be disabled.

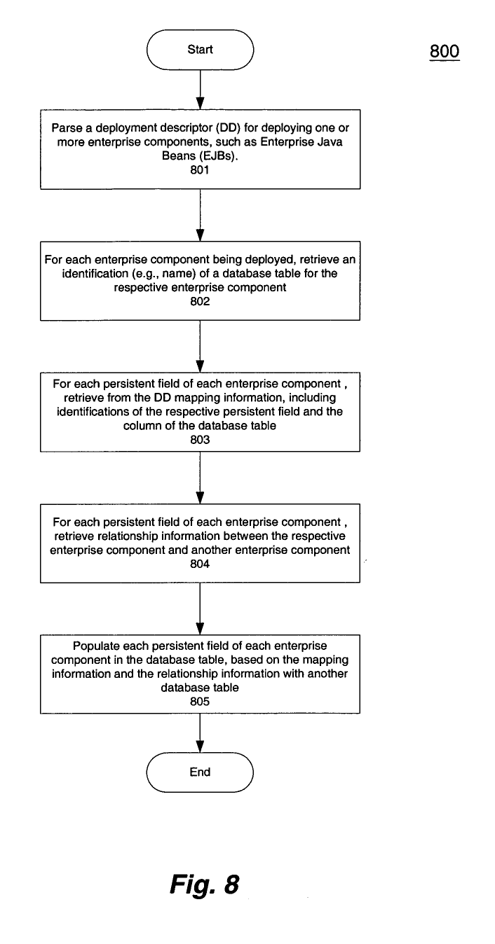

FIG. 8 is a flow diagram illustrating an exemplary process for processing deployment descriptors according to one embodiment of the invention. Exemplary process 800 may be performed by a processing logic that may include hardware (circuitry, dedicated logic, etc.), software (such as is run on a dedicated machine), or a combination of both. In one embodiment, exemplary process 800 includes, but is not limited to, parsing a deployment descriptor (DD) for deploying one or more enterprise components, for each of the enterprise components being deployed, retrieving from the DD mapping information for mapping one or more persistent fields to one or more columns of a database table, wherein for each persistent field, the mapping information includes names of the persistent field and the columns of the database table where the persistent field being mapped to, and populating each of the persistent fields of each enterprise component in the database table based on the mapping information.

Referring to FIG. 8, at block 801, a deployment descriptor is read and parsed by a deployment module of an enterprise container. One embodiment, the deployment descriptor may be constructed according to the DTD shown in FIG. 6. The deployment descriptor may be an XML compatible file. The deployment module may be a deployment module 502 of an EJB container 501 shown in FIG. 5. For each of the enterprise components being deployed (e.g., EJBs), at block 802, an identification of a database table is retrieved from the deployment descriptor.

For each of the persistent fields of each EJB, at block 803, mapping information is retrieved from the deployment descriptor. In one embodiment, the mapping information includes identifications of the respective persistent field and the column of the database table being mapped to. At block 804, for each of the relationships fields of each EJB, relationship information is retrieved from the deployment descriptor. The relationship information representing relationships between the respective EJB and another EJB. Thereafter, at block 805, each of the persistent fields of each EJB is populated in the database table according to the mapping information and the relationship information. Other operations may also be performed.

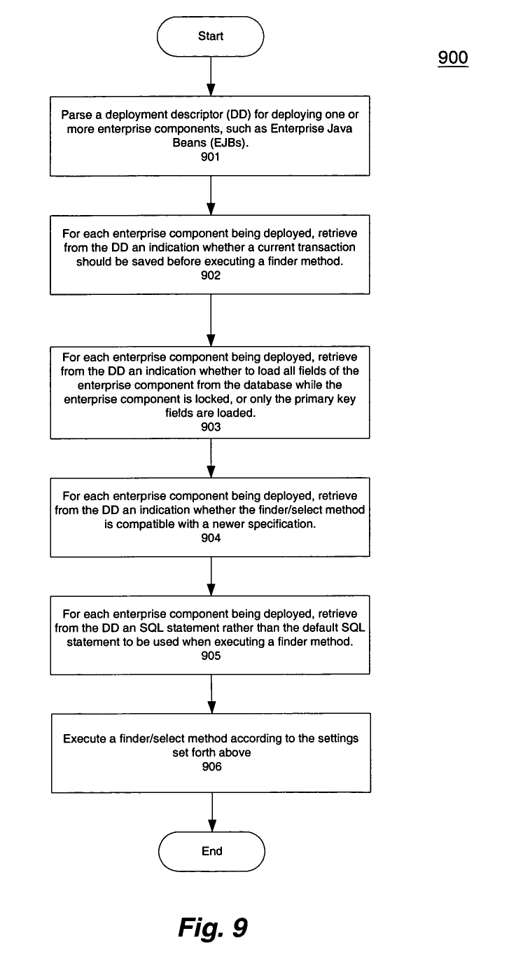

FIG. 9 is a flow diagram illustrating an exemplary process for processing deployment descriptors according to another embodiment of the invention. Exemplary process 900 may be performed by a processing logic that may include hardware (circuitry, dedicated logic, etc.), software (such as is run on a dedicated machine), or a combination of both. Referring to FIG. 9, at block 901, a deployment descriptor is read and parsed by a deployment module of an enterprise container. One embodiment, the deployment descriptor may be constructed according to the DTD shown in FIG. 6. The deployment descriptor may be an XML compatible file. The deployment module may be a deployment module 502 of an EJB container 501 shown in FIG. 5.

At block 902, for each of the EJBs being deployed, an indication is retrieved from the deployment descriptor, where the indication indicates whether a current transaction should be saved before executing a finder method of the respective EJB. If such an indication exists, according to one embodiment, the data associated with the current transaction will be saved prior to executing the finder method.

At block 903, for each of the EJBs being deployed, an indication is retrieved from the deployment descriptor, where the indication indicates whether some or all of the fields of the EJB should be loaded during executing a finder method. In one embodiment, dependent upon the setting of this indication, some or all of the fields of the EJB may be locked and loaded during an execution of the finder method. Alternatively, only the primary key fields may be loaded.

At block 904, for each of the EJBs being deployed, an indication is retrieved from the deployment descriptor, where the indication indicates whether the finder method currently submitted is compatible with a new and updated specification. If the indication indicates that the respective finer method is compatible with the new and updated specification, the finder method may be executed according to the new and updated specification.

At block 905, for each of the EJBs being deployed, an indication is retrieved from the deployment descriptor, where the indication indicates whether an alternative SQL statement other than the default SQL should be used during an execution of a finder method. Thereafter, at block 906, a finder method is executed according to at least the settings set forth in operations 902-905. Other operations may also be performed.

Exemplary Enterprise Engine Deployment Descriptors

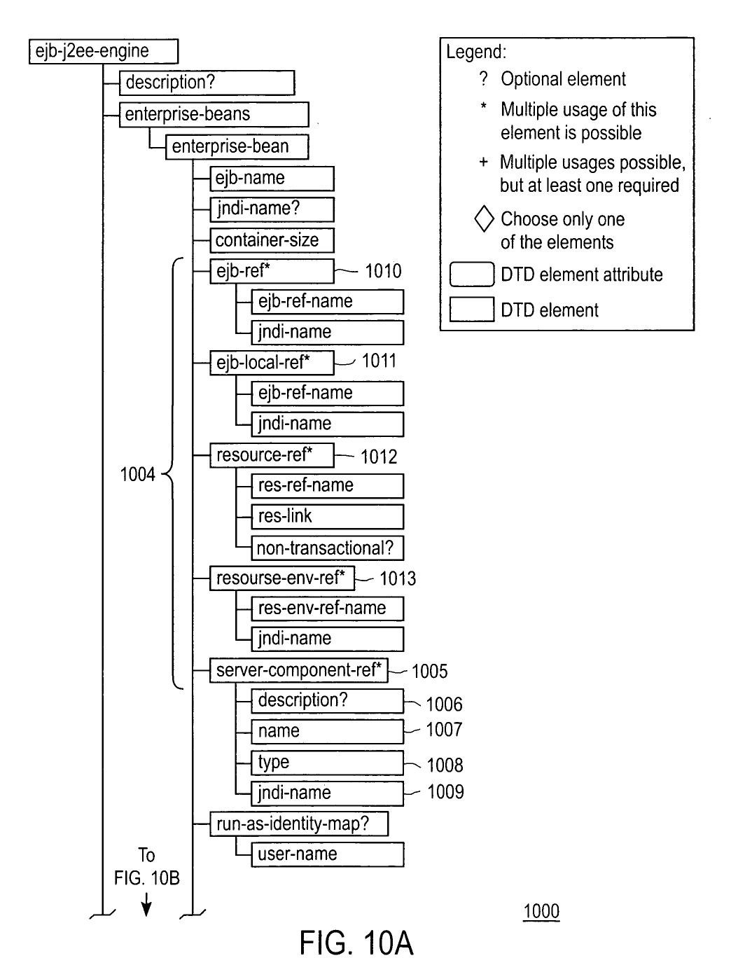

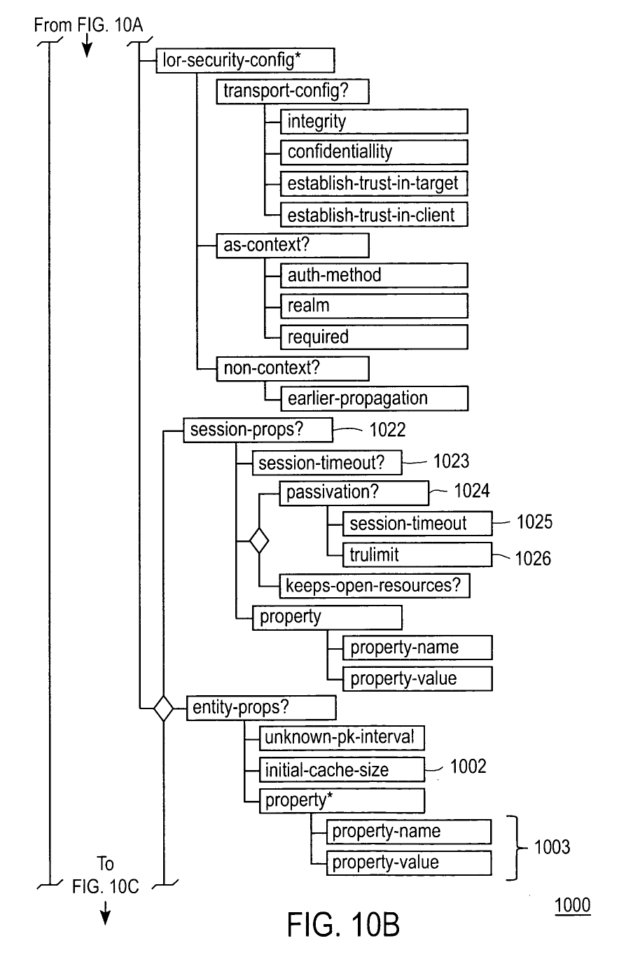

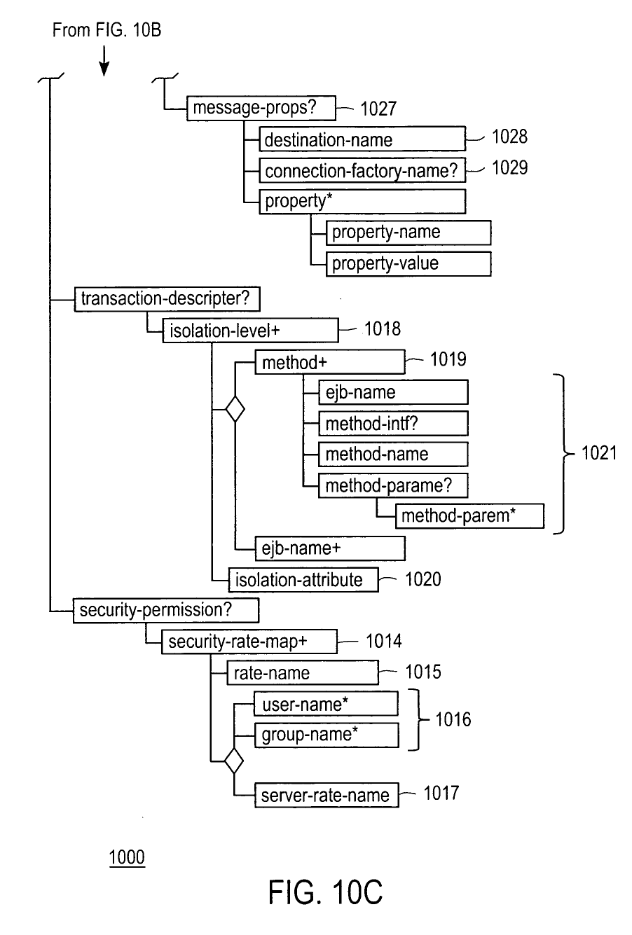

FIG. 10 is a block diagram illustrating an exemplary document type definition (DTD) of an extended deployment descriptor for an enterprise engine according to one embodiment of the invention. The exemplary DTD 1000 may be implemented in an XML format. Note that exemplary DTD 1000 is described for illustration purposes only. It will be appreciated that exemplary DTD 1000 is not limited to those elements shown in FIG. 10. Other elements may also be implemented.

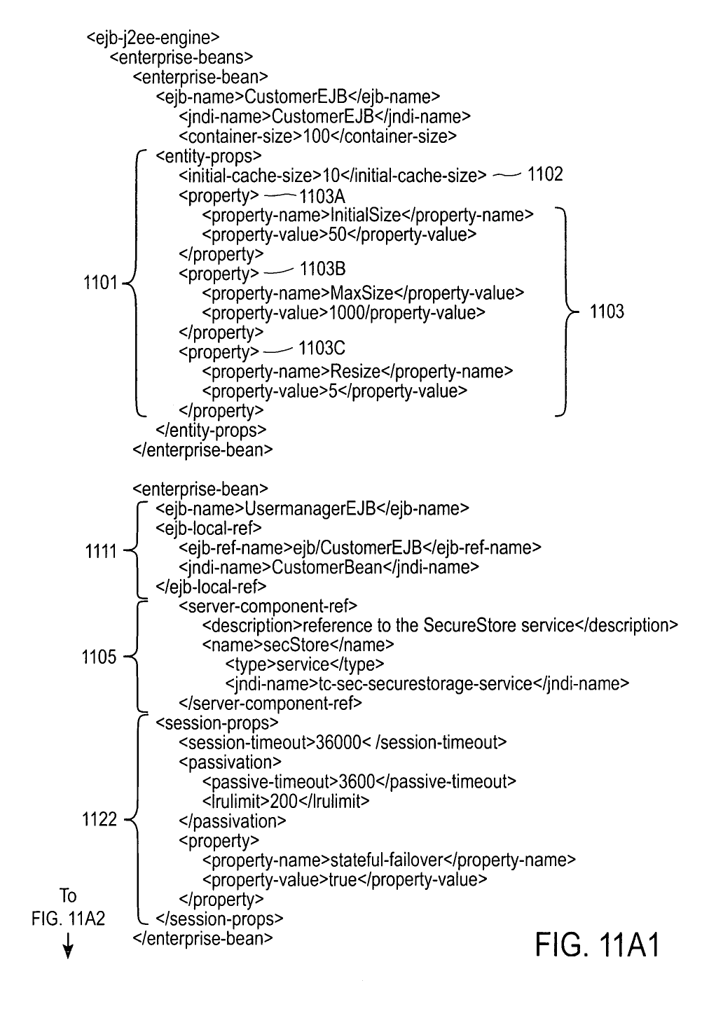

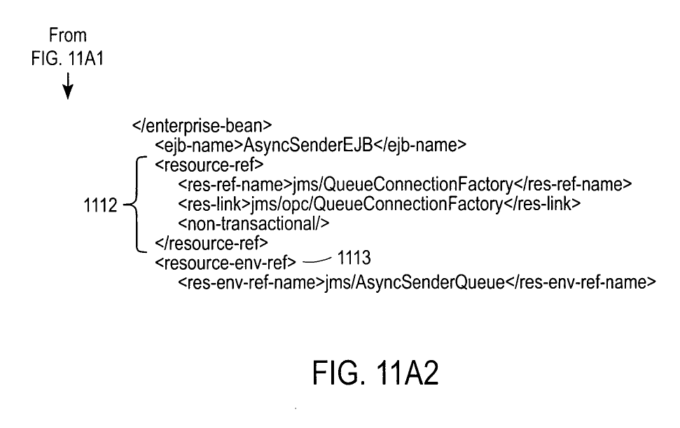

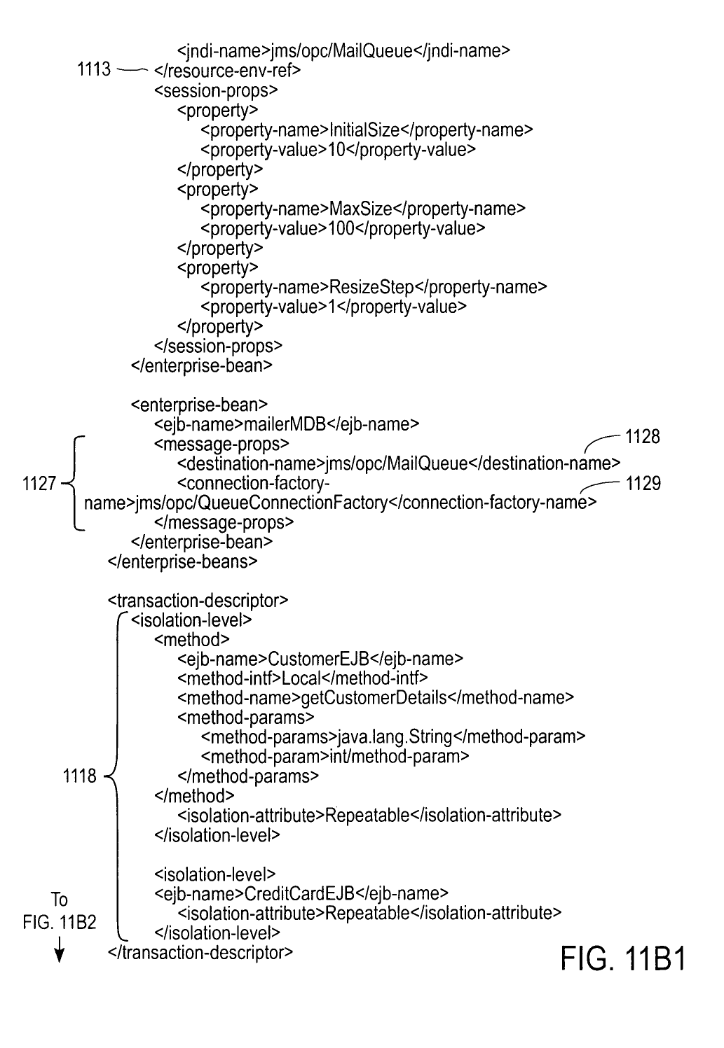

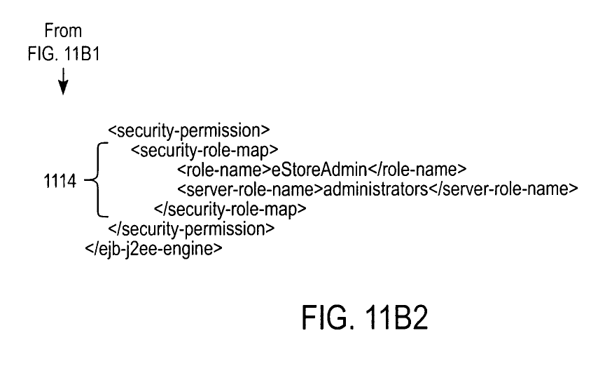

Referring to FIG. 10, in one embodiment, exemplary DTD 1000 includes one or more entity properties 1001. Within each of the entity properties 1001, an initial-cache-size tag 1002 is provided to specify an initial size of a cache memory for a persistent manager. In one embodiment, this property can be specified for container-managed entity beans only. In addition, one or more property tags 1003 may be used to further an application of the initially allocated cache memory identified by the initial-cache-size tag 1002, such as, for example, an initial size, a maximum size, and a resize step, as shown as tags 1101-1103 in an XML example shown in FIGS. 11A and 11B. Note that, FIGS. 11A and 11B are described in illustration purposes only. Other naming conventions or formats may be also be implemented. For example, other markup languages, such as, HTML (hypertext markup language), may also be utilized.

Referring back to FIG. 10, according to one embodiment, exemplary DTD 1000 may further include one or more reference sections 1004 to illustrate one or more references with respect to an enterprise component (e.g., EJB). In one embodiment, reference section 1004 includes a server component reference tag 1005. The server component may be a service, an interface, and/or a library. In one embodiment, the server component reference tag 1005 includes a description tag 1006 which may be used to provide a brief description regarding the server component being referenced. In addition, a name tag 1007 may be used to specify a name of the server component being referenced. A type tag 1008 may be used to specify the type of the server component, where the server component may be one of a service, an interface, and a library. Further, a name of the location under which the server component is registered provided. In this example, a JNDI (Java naming and directory interface) tag 1009 is used to specify the name under which the server component is registered in the JNDI. Other references, such as, an EJB reference tag 1010, an EJB local reference tag 1011, a resource reference tag 1012, and a resource environment reference tag 1013, may also be provided. Each of the references 1010-1013 may further include a JNDI tag to further specify the location of the respective reference. Examples of the above reference tags in an XML format are shown as tags 1105 and 1111-1113 in FIGS. 11A-11B.

Further, according to one embodiment, the exemplary DTD 1000 includes security-role-map tag 1014 to provide mapping information for mapping a security role of an application to a user or a server role. Under the security-role-map tag 1014, a role-name tag 1015 may be used to specify a name of the security role being mapped. A user-name tag 1016 may be used to specify a user of a user group that is identified via a group-name tag to be mapped to the security role. Alternatively, the security role may be mapped to an existing server role identified by a server-role-name tag 1017. In one embodiment, a server role is a predefined security role in the root policy configuration of an enterprise engine to which the current security role will be mapped. An example of the security mapping tag in an XML format is shown as tag 1114 in FIGS. 11A and 11B.

Further, according to one embodiment, the exemplary DTD 1000 includes a transaction descriptor section having an isolation level tag 1018 for defining transaction isolation levels for entire enterprise component or for some of its methods. Transactions not only ensure the full completion (or rollback) of the statements that they enclose but also isolate the data modified by the statements. The isolation level describes the degree to which the data being updated is visible to other transactions.

For example, suppose that a transaction in one program updates a customer's phone number, but before the transaction commits another program reads the same phone number. Will the second program read the updated and uncommitted phone number or will it read the old one? The answer depends on the isolation level of the transaction. If the transaction allows other programs to read uncommitted data, performance may improve because the other programs don't have to wait until the transaction ends. But there is a trade-off, where if the transaction rolls back, another program might read the wrong data.

Referring to FIG. 10, method tag 1019 and isolation attribute tag 1020 may be used to set an isolation level for the entire enterprise bean or alternatively, for some of its methods which are specified via tags 1021. Tags 1021 include an interface in which the method is defined, a name of the method, and parameters of the method. The isolation attribute tag 1020 may be used to specify the type of the isolation level. The type of the isolation level can be read committed or repeatable read. The corresponding values for this element are “committed” (for isolation level read committed) and/or “repeatable” (for isolation level repeatable read). The default isolation level is read committed. An example of the transaction descriptor in an XML format is shown as tag 1118 in FIGS. 11A and 11B.

Further, according to one embodiment, the exemplary DTD 1000 further includes one or more session property sections 1022 for specifying information regarding one or more enterprise session components (e.g., session beans). A session-timeout tag 1023 may be used to specify a period (in seconds) since the session was last used, after which the enterprise container may destroy it. That is, the enterprise container performs the same operation as if the bean's remove( ) method was invoked. The default session timeout is 36000 seconds. It is recommended that the value of the session-timeout is longer than the expected duration of the methods; otherwise, this will lead to system errors. A passivation tag 1024 may be used to specify whether an EJB container passivates the bean instances. If this element is omitted in the deployment descriptor, according to one embodiment, the EJB container will not passivate the bean instances. In one embodiment, this property can be specified for stateful session beans only.

According to one embodiment, the passive timeout tag may be used to specify the period (in seconds) since the bean's passivation, after which the EJB Container clears the session bean's instance from the swap and destroys the session. In addition, a LRU (least recently used) limit tag may be used to specify the maximum number of active sessions in the EJB container. Once this number is reached, the EJB container passivates the session that was used least recently (LRU algorithm) and swaps its instance to the hard disk. An example of the above descriptor in an XML format is shown as tag 1122 in FIGS. 11A and 11B.

Further, a keeps-open-resources tag 1025 may be used to specify that the enterprise bean holds open resources. This means that the enterprise bean's ejbPassivate( ) method must be executed before serializing the enterprise bean. In one embodiment, this element is used only when the application is set to use failover.

According to one embodiment, the exemplary DTD 1000 further includes a message driven component (e.g., message driven bean in a Java environment) section 1027 to specify information about the message-driven component in an enterprise application. Under the tag 1027, a destination-name tag 1028 may be used to specify a name of the topic or the queue to which the enterprise component wants to be subscribed. In addition, a connection factory name tag 1029 may be used to specify a name of the connection factory that will be used by the enterprise container to obtain connections in order to register the enterprise component as a message listener. An example of the above descriptor in an XML format is shown as tag 1127 in FIGS. 11A and 11B.

It will be appreciated that other properties may also be implemented. For example, additional properties of the enterprise component may also be specified, such as, for example, a property having the following property members:
InitialSize—the initial number of instances that will be created in the pool.
MaxSize—the maximum number of instances that can exist in the pool.
ResizeStep—the number, by which the total number of instances in the pool will be incremented each time a new instance is requested and there are no idle instances in the pool. The value of this element must be positive.
PoolClass—the implementation class of the pool. The possible values for this property may be, for example: com.sap.engine.services.ejb.util.pool.ContainerPoolImpl (for stateless session and entity beans) and com.sap.engine.services.ejb.message.SrvSessionPool (for message-driven beans).

Stateful-failover—enables stateful failover for stateful session beans. The possible values for this property are true and false. This property enables stateful failover for stateful session components (e.g., session beans). If some server nodes in the cluster fail, all the active sessions on those server nodes may be replicated or transferred to another server node and the client or clients will not lose the respective information.

These properties may be set for stateless session beans, message-driven beans, and entity beans in a Java environment, whose containers use pools with instances. Other configurations may exist.

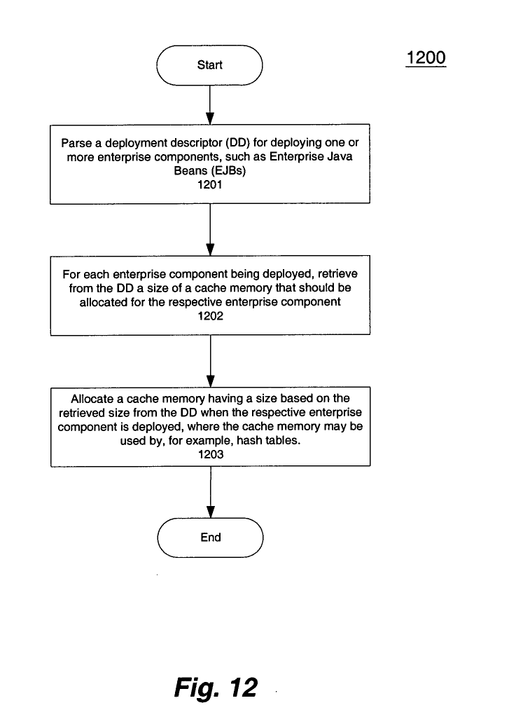

FIG. 12 is a flow diagram illustrating an exemplary process for processing deployment descriptor of an enterprise engine, according to one embodiment of the invention. Exemplary process 1200 may be performed by a processing logic that may include hardware (circuitry, dedicated logic, etc.), software (such as is run on a dedicated machine), or a combination of both. In one embodiment, exemplary process 1200 includes, but is not limited to, parsing a deployment descriptor (DD) for deploying one or more enterprise components, for each of the enterprise components being deployed, retrieving from the DD an initial cache size specifying a size of a cache memory initially allocated to the enterprise component when the enterprise component is being deployed, and allocating a cache memory for the enterprise component having a size according to the initial cache size retrieved from the DD during a deployment of the enterprise component.

Referring to FIG. 12, at block 1201, a deployment descriptor is read and parsed by a deployment module of an enterprise container. One embodiment, the deployment descriptor may be constructed according to the DTD shown in FIG. 10. The deployment descriptor may be an XML compatible file. The deployment module may be a deployment module 502 of an EJB container 501 shown in FIG. 5. At block 1202, for each enterprise component (e.g., EJB) being deployed, an initial size of a cache memory is retrieved from the deployment descriptor. The initial size of the cache memory may be specified via a tag of the deployment descriptor, such as, for example, tag 1002 of exemplary DTD 1000 shown in FIG. 10. The initial size of the cache memory indicates the size of a cache memory should be initially allocated for the respective enterprise component. At block 1203, when the respective enterprise component is deployed, a block of cache memory is allocated for the respective enterprise component according to the initial size retrieved from the deployment descriptor. Other operations may also be performed.

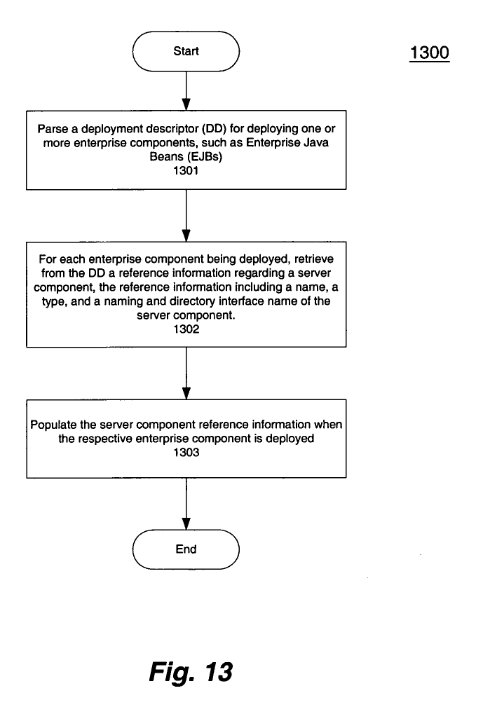

FIG. 13 is a flow diagram illustrating an exemplary process for processing deployment descriptor of an enterprise engine, according to one embodiment of the invention. Exemplary process 1300 may be performed by a processing logic that may include hardware (circuitry, dedicated logic, etc.), software (such as is run on a dedicated machine), or a combination of both. Referring to FIG. 13, at block 1301, a deployment descriptor is read and parsed by a deployment module of an enterprise container. One embodiment, the deployment descriptor may be constructed according to the DTD shown in FIG. 10. The deployment descriptor may be an XML compatible file. The deployment module may be a deployment module 502 of an EJB container 501 shown in FIG. 5. At block 1302, for each of the enterprise components being deployed, reference information regarding a server component is retrieved from the deployment descriptor. In one embodiment, the reference information includes a name, a type, and a naming and directory interface name associated with the server component. The server component may be a service, an interface, and/or a library of a server node. At block 1303, when the respective enterprise component is deployed, the server component reference information retrieved from the deployment descriptor is populated. Other operations may also be performed.

Exemplary Data Processing System

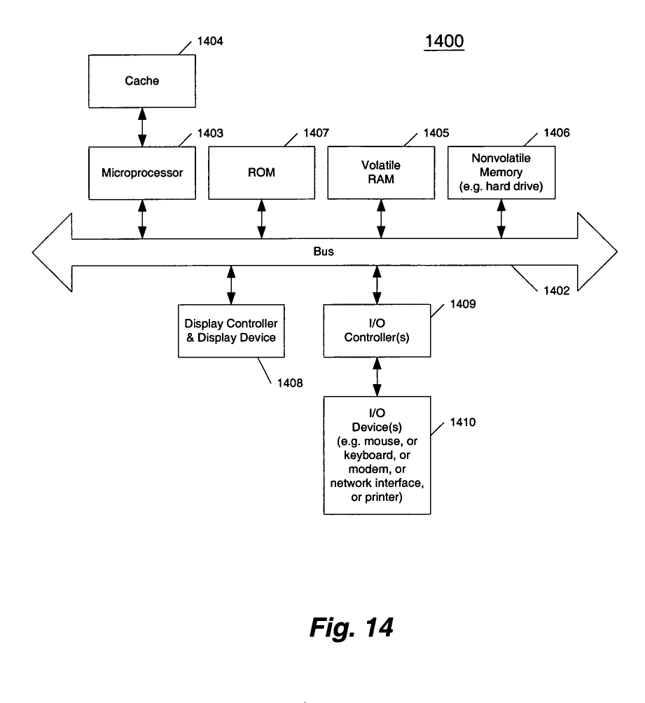

FIG. 14 is a block diagram of a data processing system which may be used with one embodiment of the invention. For example, the system 1400 shown in FIG. 14 may be used as an enterprise computing engine or a client.

Note that while FIG. 14 illustrates various components of a computer system, it is not intended to represent any particular architecture or manner of interconnecting the components, as such details are not germane to the present invention. It will also be appreciated that network computers, handheld computers, cell phones, and other data processing systems which have fewer components or perhaps more components may also be used with the present invention. The computer system of FIG. 14 may, for example, be a J2EE engine or a NET framework engine.

As shown in FIG. 14, the computer system 1400, which is a form of a data processing system, includes a bus 1402 which is coupled to a microprocessor 1403 and a ROM 1407, a volatile RAM 1405, and a non-volatile memory 1406. The microprocessor 1403, which may be a PowerPC microprocessor from Motorola, Inc. or IBM, is coupled to cache memory 1404 as shown in the example of FIG. 14. Alternatively, processor 1403 may be a Pentium Processor from Intel Corporation.

The bus 1402 interconnects these various components together and also interconnects these components 1403, 1407, 1405, and 1406 to a display controller and display device 1408, as well as to input/output (I/O) devices 1410, which may be mice, keyboards, modems, network interfaces, printers, and other devices which are well-known in the art. Typically, the input/output devices 1410 are coupled to the system through input/output controllers 1409.

The volatile RAM 1405 is typically implemented as dynamic RAM (DRAM) which requires power continuously in order to refresh or maintain the data in the memory. The non-volatile memory 1406 is typically a magnetic hard drive, a magnetic optical drive, an optical drive, or a DVD RAM or other type of memory system which maintains data even after power is removed from the system. Typically the non-volatile memory will also be a random access memory, although this is not required. While FIG. 14 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 1402 may include one or more buses connected to each other through various bridges, controllers, and/or adapters, as is well-known in the art. In one embodiment, the I/O controller 1409 includes a USB (Universal Serial Bus) adapter for controlling USB peripherals.

According to one embodiment, the exemplary system 1400 further includes a deployment module, which when executed from the memory, deploys one or more enterprise components based on the information retrieved from one or more deployment descriptors.

Exemplary Persistent DTD Descriptions

Following descriptions describe detailed information regarding the exemplary persistent DTD 600 of FIG. 6, in addition to those described above according to one embodiment.

[image]

[image]

[image]

[image]

[image]

[image]

[image]

[image]

[image]

Exemplary Enterprise Engine DTD Descriptions

Following descriptions describe detailed information regarding the exemplary enterprise engine DTD 1000 of FIG. 10, in addition to those described above according to one embodiment.

[image]

[image]

[image]

[image]

[image]

[image]

[image]

[image]

[image]

[image]

[image]

[image]

[image]

[image]

Thus, system and method for deploying enterprise components using a deployment descriptor have been described herein. Note that although a Java computing environment has been used throughout this application, embodiments of the present application are not limited to the Java computing environment. It will be appreciated that other computing environments, such as, for example, the NET framework environment from Microsoft may also be applied. The examples of deployment descriptors described above are for illustration purposes only. It will be appreciated that other formats or scripting languages may also be utilized.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
parsing a deployment descriptor (DD) for deploying one or more enterprise components;
for each of the enterprise components being deployed, retrieving from the DD mapping information for mapping one or more persistent fields to one or more columns of a database table, wherein for each persistent field, the mapping information includes names of the persistent field and the columns of the database table where the persistent field being mapped to; and
populating each of the persistent fields of each enterprise component in the database table based on the mapping information.

2. The method of claim 1, wherein the DD is an extensible markup language (XML) file.

3. The method of claim 1, further comprising retrieving from the DD an identification of the database table where the one or more persistent fields are mapped to.

4. The method of claim 1, wherein the mapping information further comprises a key-type field that specifies a key associated with the persistent field, and wherein the key is one of no key, a primary key, and a unique key.

5. The method of claim 1, wherein at least one persistent field is mapped to a plurality of columns of the database table, and wherein the mapping information further comprises one or more sub-names of the persistent fields and a column name associated with each sub-name.

6. The method of claim 1, wherein the mapping information further comprises relationship information to relate a relationship field to a foreign key column of another database table, and wherein the relationship information comprises a key-type indicating a type of key associated with the relationship field and the foreign key column of the database table.

7. The method of claim 6, wherein if the key type is a primary key, the relationship information further comprises a container managed relationship (CMR) field name for identifying the relationship field.

8. The method of claim 7, wherein if the key type is a key other than a primary key, the relationship information further comprises a foreign column name and the primary key field name of the database table that the CMR field is mapped to.

9. The method of claim 1, further comprising:
retrieving from the DD a switch-off-storing indication indicating whether a current transaction should be stored in the database table prior to executing a finder method of the enterprise component; and
executing the finder method without storing the current transaction if the switch-off-storing indication is specified.

10. The method of claim 1, further comprising:
retrieving from the DD a load-selected-object indication indicating whether which fields should be loaded from the database table during executing a finder method of the enterprise component; and
loading the fields specified by the load-selected-object indication during executing the finder method of the enterprise component.

11. The method of claim 1, further comprising:
retrieving from the DD an indication indicating whether a finder method of the enterprise component is compatible with an updated specification prior to executing the finder method of the enterprise component; and
executing the finder method according to the updated specification if the indication is specified.

12. The method of claim 1, further comprising:
retrieving a criteria information from the DD, the criteria information including a SQL statement other than a default SQL statement used in a finder method; and
executing the finder method using the criteria information retrieved from the DD rather than the default SQL statement.

13. The method of claim 1, further comprising:
retrieving from the DD locking information for controlling concurrent access from different transactions to the respective enterprise component;
performing locking operations on the enterprise component based on the locking information retrieved from the DD.

14. The method of claim 13, wherein the locking information comprises at least one of the following:
table locking that automatically locks the enterprise component in an Enqueue server;
administrative locking; and
local locking that synchronizes the concurrent access on one server.

15. The method of claim 13, further comprising retrieving a select-for-update indication that indicates the enterprise component will use database locking, which is set forth by the locking information.

16. The method of claim 1, further comprising:
retrieving from the DD a create-tables-at-deploy indication requesting creating a default relational database schema during a deployment of the enterprise component; and
creating the default relational database schema while deploying the enterprise component if the create-tables-at-deploy indication exists in the DD.

17. The method of claim 1, further comprising:
retrieving from the DD a switch-off-verification indication requesting suspension of an object/relational mapping verification during a deployment of the enterprise component; and
deploying the enterprise component without performing the object/relational mapping verification if the switch-off-verification indication exists in the DD.

18. A machine-readable medium having executable code to cause a machine to perform a method, the method comprising:
parsing a deployment descriptor (DD) for deploying one or more enterprise components;
for each of the enterprise components being deployed, retrieving from the DD mapping information for mapping one or more persistent fields to one or more columns of a database table, wherein for each persistent field, the mapping information includes names of the persistent field and the columns of the database table where the persistent field being mapped to; and
populating each of the persistent fields of each enterprise component in the database table based on the mapping information.

19. The machine-readable medium of claim 18, wherein the DD is an extensible markup language (XML) file.

20. The machine-readable medium of claim 18, wherein the method further comprises retrieving from the DD an identification of the database table where the one or more persistent fields are mapped to.

21. The machine-readable medium of claim 18, wherein the mapping information further comprises a key-type field that specifies a key associated with the persistent field, and wherein the key is one of no key, a primary key, and a unique key.

22. The machine-readable medium of claim 18, wherein at least one persistent field is mapped to a plurality of columns of the databaes table, and wherein the mapping information further comprises one or more sub-names of the persistent fields and a column name associated with each sub-name.

23. The machine-readable medium of claim 18, wherein the mapping information further comprises relationship information to relate a relationship field to a foreign key column of another database table, and wherein the relationship information comprises a key-type indicating a type of key associated with the relationship field and the foreign key column of the database table.

24. The machine-readable medium of claim 23, wherein if the key type is a primary key, the relationship information further comprises a container managed relationship (CMR) field name for identifying the relationship field.

25. The machine-readable medium of claim 24, wherein if the key type is a key other than a primary key, the relationship information further comprises a foreign column name and the primary key field name of the database table that the CMR field is mapped to.

26. The machine-readable medium of claim 18, wherein the method further comprises:
retrieving from the DD a switch-off-storing indication indicating whether a current transaction should be stored in the database table prior to executing a finder method of the enterprise component; and
executing the finder method without storing the current transaction if the switch-off-storing indication is specified.

27. The machine-readable medium of claim 18, wherein the method further comprises:
retrieving from the DD a load-selected-object indication indicating whether which fields should be loaded from the database table during executing a finder method of the enterprise component; and
loading the fields specified by the load-selected-object indication during executing the finder method of the enterprise component.

28. The machine-readable medium of claim 18, wherein the method further comprises:
retrieving from the DD an indication indicating whether a finder method of the enterprise component is compatible with an updated specification prior to executing the finder method of the enterprise component; and
executing the finder method according to the updated specification if the indication is specified.

29. The machine-readable medium of claim 18, wherein the method further comprises:
retrieving a criteria information from the DD, the criteria information including a SQL statement other than a default SQL statement used in a finder method; and
executing the finder method using the criteria information retrieved from the DD rather than the default SQL statement.

30. The machine-readable medium of claim 18, wherein the method further comprises:
retrieving from the DD locking information for controlling concurrent access from different transactions to the respective enterprise component;
performing locking operations on the enterprise component based on the locking information retrieved from the DD.

31. The machine-readable medium of claim 30, wherein the locking information comprises at least one of the following:
table locking that automatically locks the enterprise component in an Enqueue server;
administrative locking; and
local locking that synchronizes the concurrent access on one server.

32. The machine-readable medium of claim 30, wherein the method further comprises retrieving a select-for-update indication that indicates the enterprise component will use database locking, which is set forth by the locking information.

33. The machine-readable medium of claim 18, wherein the method further comprises:
retrieving from the DD a create-tables-at-deploy indication requesting creating a default relational database schema during a deployment of the enterprise component; and
creating the default relational database schema while deploying the enterprise component if the create-tables-at-deploy indication exists in the DD.

34. The machine-readable medium of claim 18, wherein the method further comprises:
retrieving from the DD a switch-off-verification indication requesting suspension of an object/relational mapping verification during a deployment of the enterprise component; and
deploying the enterprise component without performing the object/relational mapping verification if the switch-off-verification indication exists in the DD.

35. A data processing system, comprising:
a processor;
a memory coupled to the processor having instructions, when executed from the memory, cause the processor to
parse a deployment descriptor (DD) for deploying one or more enterprise components,
for each of the enterprise components being deployed, retrieve from the DD mapping information for mapping one or more persistent fields to one or more columns of a database table, wherein for each persistent field, the mapping information includes names of the persistent field and the columns of the database table where the persistent field being mapped to, and
populate each of the persistent fields of each enterprise component in the database table based on the mapping information.

36. An apparatus, comprising:
means for parsing a deployment descriptor (DD) for deploying one or more enterprise components;
for each of the enterprise components being deployed, means for retrieving from the DD mapping information for mapping one or more persistent fields to one or more columns of a database table, wherein for each persistent field, the mapping information includes names of the persistent field and the columns of the database table where the persistent field being mapped to; and
means for populating each of the persistent fields of each enterprise component in the database table based on the mapping information.

37. A method, comprising:
parsing a deployment descriptor (DD) for deploying one or more enterprise components;
for each of the enterprise components being deployed, retrieving from the DD an initial cache size specifying a size of a cache memory initially allocated to the enterprise component when the enterprise component is being deployed; and
allocating a cache memory for the enterprise component having a size according to the initial cache size retrieved from the DD during a deployment of the enterprise component.

38. The method of claim 37, wherein the DD is an extensible markup language (XML) file.

39. The method of claim 37, further comprising:
retrieving from the DD reference information with respect to a server component, the reference information including at least one of a name, a type, and a location of the server component; and
referencing the server component during a deployment of the enterprise component using the reference information retrieved from the DD.

40. The method of claim 39, wherein the type of the server component includes one of a service, an interface, and a library of a server component.

41. The method of claim 39, wherein the location of the server component includes a name under which the server component is registered in a naming and directory interface.

42. The method of claim 39, wherein the reference information further comprises a description tag for describing the server component.

43. The method of claim 37, further comprising:
retrieving from the DD mapping information for mapping an application security role to one of a user, a group of users, and a predetermined security role in a server environment; and
mapping the application security role according to the mapping information.

44. The method of claim 43, wherein the mapping information comprises an identity of the application security role.

45. The method of claim 44, wherein the mapping information further comprises a name of a user and a group of users that the application security role is being mapped to.

46. The method of claim 37, further comprising:
retrieving isolation level information from the DD, the isolation information specifying a degree to which data being updated is visible to other transactions; and
setting an isolation level in one or more transaction attributes of the enterprise component when the enterprise component is deployed, based on the isolation level information retrieved from the DD.

47. The method of claim 46, wherein the isolation level information comprises a method information regarding a method to which a transaction attribute is set, the method information including at least one of a name, an interface, and one or more parameters of the method.

48. The method of claim 46, wherein the isolation level information further comprises an isolation attribute for specifying a type of the isolation level, the isolation attribute including one of a read committed and a repeatable read attributes.

49. The method of claim 37, further comprising:
retrieving from the DD a keeps-open-resources indication indicating that a passivation method needs to be executed prior to serializing the enterprise component; and
executing the passivation method prior to serializing the enterprise component if the keeps-open-resources indication exists in the DD.

50. The method of claim 49, further comprising disabling passivation of the enterprise component if the keeps-open-resources indication exists in the DD.

51. The method of claim 37, further comprising:
retrieving from the DD one or more properties of a message-driven component associated with the enterprise component being deployed; and
configuring the message-driven component based on the one or more properties retrieved from the DD.

52. The method of claim 51, wherein the one or more properties comprise a name of one of a topic and queue that the message-driven component desires to be subscribed.

53. The method of claim 52, wherein the one or more properties further comprise a name of connection factory that is used by an enterprise container to obtain connections in order to register the enterprise component as a listener.

54. The method of claim 37, further comprising:
retrieving from the DD a stateful-failover indication; and
enabling stateful failover for stateful session components in response to the stateful-failover indication.

55. The method of claim 54, wherein when one or more server nodes fails, substantially all the active sessions on the failed server nodes are replicated to another server when the stateful-failover indication is set to a predetermined value.

56. A machine-readable medium having executable code to cause a machine to perform a method, the method comprising:
parsing a deployment descriptor (DD) for deploying one or more enterprise components;
for each of the enterprise components being deployed, retrieving from the DD an initial cache size specifying a size of a cache memory initially allocated to the enterprise component when the enterprise component is being deployed; and
allocating a cache memory for the enterprise component having a size according to the initial cache size retrieved from the DD during a deployment of the enterprise component.

57. The machine-readable medium of claim 56, wherein the DD is an extensible markup language (XML) file.

58. The machine-readable medium of claim 56, wherein the method further comprises:
retrieving from the DD reference information with respect to a server component, the reference information including at least one of a name, a type, and a location of the server component; and
referencing the server component during a deployment of the enterprise component using the reference information retrieved from the DD.

59. The machine-readable medium of claim 58, wherein the type of the server component includes one of a service, an interface, and a library of a server component.

60. The machine-readable medium of claim 58, wherein the location of the server component includes a name under which the server component is registered in a naming and directory interface.

61. The machine-readable medium of claim 58, wherein the reference information further comprises a description tag for describing the server component.

62. The machine-readable medium of claim 56, wherein the method further comprises:
retrieving from the DD mapping information for mapping an application security role to one of a user, a group of users, and a predetermined security role in a server environment; and
mapping the application security role according to the mapping information.

63. The machine-readable medium of claim 62, wherein the mapping information comprises an identity of the application security role.

64. The machine-readable medium of claim 63, wherein the mapping information further comprises a name of a user and a group of users that the application security role is being mapped to.

65. The machine-readable medium of claim 56, wherein the method further comprises:
retrieving isolation level information from the DD, the isolation information specifying a degree to which data being updated is visible to other transactions; and
setting an isolation level in one or more transaction attributes of the enterprise component when the enterprise component is deployed, based on the isolation level information retrieved from the DD.

66. The machine-readable medium of claim 65, wherein the isolation level information comprises a method information regarding a method to which a transaction attribute is set, the method information including at least one of a name, an interface, and one or more parameters of the method.

67. The machine-readable medium of claim 65, wherein the isolation level information further comprises an isolation attribute for specifying a type of the isolation level, the isolation attribute including one of a read committed and a repeatable read attributes.

68. A data processing system, comprising:
a processor;
a memory coupled to the processor having instructions, when executed from the memory, cause the processor to
parse a deployment descriptor (DD) for deploying one or more enterprise components,
for each of the enterprise components being deployed, retrieve from the DD an initial cache size specifying a size of a cache memory initially allocated to the enterprise component when the enterprise component is being deployed, and
allocate a cache memory for the enterprise component having a size according to the initial cache size retrieved from the DD during a deployment of the enterprise component.

69. An apparatus, comprising:
means for parsing a deployment descriptor (DD) for deploying one or more enterprise components;
for each of the enterprise components being deployed, means for retrieving from the DD an initial cache size specifying a size of a cache memory initially allocated to the enterprise component when the enterprise component is being deployed; and
means for allocating a cache memory for the enterprise component having a size according to the initial cache size retrieved from the DD during a deployment of the enterprise component.
